(19) United States
(12) Patent Application Publication
(10) Pub. No.: US 2022/0142193 A1
(43) Pub. Date: May 12, 2022

(54) PROGRESSIVE SHEAR EMULSIFIER

(71) Applicant: Seattle Food Tech, Inc., Seattle, WA (US)

(72) Inventors: Christie Dustry Lagally, Seattle, WA (US); Julia O'Donnell, Seattle, WA (US); Jeffray Behr, Burlington (CA)

(21) Appl. No.: 17/518,513

(22) Filed: Nov. 3, 2021

Related U.S. Application Data
(60) Provisional application No. 63/112,918, filed on Nov. 12, 2020.

(51) Int. Cl. A23D 7/04; A23L 19/00; A23L 29/262; A23D 7/005; B01F 7/00; B01F 3/08; B01F 15/06

(52) U.S. Cl. CPC A23D 7/04; A23L 19/09; A23L 29/262; A23D 7/0053; B01F 7/00825; A23V 2002/00; B01F 3/0853; B01F 3/088; B01F 15/065; B01F 2015/061; B01F 2215/0014; B01F 3/0811

(57) ABSTRACT

A progressive shear emulsifier can include an outer body and an inner body. The outer body can have a central opening therethrough, an inlet, an outlet, and an inner surface along the central opening defining a first three-dimensional contour. The inner body can be positioned within the central opening and configured to rotate with respect to the outer body about an axis of rotation along the central opening. The inner body can have an outer surface defining a second three-dimensional contour that correlates to the first three-dimensional contour to form a material passage between the outer body and inner body. Rotation of the inner body within the outer body can create progressive amounts of shear across materials passing through the material passage, which can result in emulsified material. Conic transitions can create turbulent regions that mix the materials passing therethrough. Collective geometry can create conveyance and/or pumping of materials, which can be methylcellulose and free water.

### CROSS-REFERENCE TO RELATED APPLICATION

This application claims priority to U.S. Provisional Patent Application No. 63/112,918, filed Nov. 12, 2020, which is hereby incorporated by reference in its entirety.

### TECHNICAL FIELD

The present disclosure relates generally to food processing, and more particularly to devices and methods that can be used in the formation of meat analogue products.

### BACKGROUND

Plant-based meat production is a growing industry, and plant-based meat products are becoming increasingly popular due to the improving quality and appeal of these products. One important aspect of plant-based meat production as well as meat analogue production in general is to bind various ingredients together during processing. The use of binders and stabilizers in meat analogue production is common, and results in products having better texture, moisture, and appeal to consumers. Methylcellulose is an ingredient in well over half of plant-based meat products, for example, and this common ingredient functions as a structuring and binding agent for fat (oil) and free water in a food processing mixture to result in an appealing plant-based meat product. Methylcellulose also serves other functional purposes, such as providing structure in a final food product. Virtually all producers of plant-based meat products structure liquid fat through binding methylcellulose to water in at least some of their products, and it is generally well known that this binding aspect is an important part of the plant-based meat production industry.

Unfortunately, structuring fat through binding methylcellulose to free water has traditionally been a very inefficient and labor intensive process. During processing, various food ingredients are often mixed into a dough that includes methylcellulose and free water, water that is not already molecularly bound to any other food ingredient. A significant amount of shear stress and turbulence is then needed to disperse and bind the methylcellulose to the free water in the dough. In fact, shear stress is often used in food processing to bind many other forms of binders and stabilizers to water, oil, and/or other foodstuff powders, doughs, fluids, or other materials. The application of shear stress and turbulence to dough can be accomplished by few pieces of equipment in food processing, such as bowl choppers and other typical animal meat processing items.

A bowl chopper typically applies shear stress on a dough mixture only at the surfaces of its rotating blades, such that shear is applied to the dough at only about 2-10 square inches of surface area at a time and only for fractions of a second at a time every time the bowl chopper rotates dough material into the field of impact of its blades. As such, each portion of dough spends over 90 percent of its time in a bowl chopper outside of the rotating blade field of impact. This is highly inefficient since no shear stress is being applied to the portions of dough that are outside the rotating blade field of impact and areas of the mixture can be missed by the mixing blade leading to the formation of dead spots and result in less efficient mixing. Further, the rotating blade action of the bowl chopper adds heat to the dough. Added heat is an inherent food safety risk and may affect the chemistry of binding water with an emulsifying agent, resulting in the need for temperature controls, even more processing, and greater inefficiencies. Other traditional food processing items capable of providing shear stresses on a highly viscous dough or other foodstuff mixture, such as a dough hook or colloid mill, are less efficient than bowl choppers, present other processing challenges such as clogging or burning, or both.

Since traditional ways of processing food products have worked inefficiently when applied to plant-based meat and meat analogue products, improvements to existing techniques are desired. In particular, what is desired are improved systems, methods, and processes for binding different components within a meat analogue mixture or other food product during processing.

### SUMMARY

It is an advantage of the present disclosure to provide improved systems and methods for binding different components of a food product and structuring fat during processing, such as methylcellulose, oil, and water for a meat analogue product. The disclosed features, apparatuses, systems, and methods provide improved fluid and material binding, turbulent mixing, and conveyance solutions that involve a more efficient way to impart shear stresses onto foodstuffs, fluids, and other materials in a continuous fashion. These advantages can be accomplished at least in part by flowing foodstuffs and/or other materials through a narrow material passage while moving at least one material passage wall to impart shear stresses to the materials.

In various embodiments of the present disclosure, an apparatus configured to emulsify fluids and other materials can include a first body and a second body. The first body can include an inlet, an outlet, and a first surface between the inlet and outlet. The first surface can define a first three-dimensional contour having a size, a shape, and one or more directional changes. The second body can have a second surface that defines a second three-dimensional contour having a size, shape, and one or more directional changes, with the second three-dimensional contour correlating to the first three-dimensional contour to form a material passage between the first body and second body. Movement of the second body relative to the first body can create substantial amounts of shear from the inlet to the outlet across all materials passing through the material passage, and these substantial amounts of shear can emulsify a first material with a second material in the material passage.

In various detailed embodiments, the first material can include free water, the second material can include methylcellulose, and the third material can include oil. A substantial amount of shear and turbulence can be sufficient to bind the methylcellulose to the free water and dropletize the oil within the hydrocolloid gel network. The first material can be a pre-mixed suspension of oil within water in some arrangements or, alternatively, a mixture of water, oil, and a low concentration of methylcellulose. The second material can be some higher concentration of methylcellulose. Additional material mixtures are also possible. The second body can substantially fit within the first body, and the first body can remain stationary while the second body rotates within the first body. The first surface can include substantially most inner surface regions of the first body and the second surface can include substantially most outer surface regions of the second body. In some arrangements, the second body can include one or more features configured to facilitate rotational movement of the second body.

In further detailed embodiments, a first portion of the second surface can form a first conical shape with respect to an axis of rotation of the second body, and this first conical shape can have a cross-section diameter that increases toward the outlet. The substantial amounts of shear can then include progressive shear which increases as materials travel along the first conical shape. The second surface can include one or more grooves configured to facilitate material flow therealong. A second portion of the second surface can form a second conical shape with respect to the axis of rotation, and this second conical shape can also have a cross-section diameter that increases toward the outlet. A directional change of the second surface can include a conic transition from an end of the first conical shape to a start of the second conical shape. This conic transition can create a turbulent region in the material passage proximate thereto, where the turbulent region mixes the first material and second material. All or most of the second material can be emulsified with the first material before the first and second materials reach an end of the first conical shape.

In various further embodiments of the present disclosure, a progressive shear emulsifier is configured to emulsify a first foodstuff with a second foodstuff in various detailed arrangements and can include an outer body and an inner body. The outer body can have a central opening therethrough, an inlet, an outlet, and an inner surface along the central opening between the inlet and outlet. The inner surface can define a first three-dimensional contour having a size, a shape, and one or more directional changes. The inner body can be positioned within the central opening of the outer body and can be configured to rotate with respect to the outer body. The inner body can have an axis of rotation along the central opening and an outer surface that defines a second three-dimensional contour having a size, shape, and one or more directional changes that correlate to the first three-dimensional contour to form a material passage between the outer body and inner body. Rotation of the inner body within the outer body can create progressive amounts of shear across the first foodstuff and the second foodstuff passing through the material passage from the inlet to the outlet, and these progressive amounts of shear can result in all or most of the second foodstuff being emulsified with the first foodstuff while the first and second foodstuffs are within the material passage.

In various detailed embodiments, the first foodstuff can include an oil and free water mixture and the second foodstuff can include methylcellulose. In another detailed arrangement the first food stuff could include a mixture of water, oil, and some concentration of methylcellulose and the second foodstuff could include methylcellulose. The outer body and the inner body can both be symmetrical about the axis of rotation. The inner body can include a first conical region having a cross-section diameter that increases along the axis of rotation toward the outlet, and the outer surface can include one or more grooves configured to facilitate material flow therealong. The inner body can further include a second conical region after the first conical region and a conic transition between the first and second conical regions. The second conical region can have a cross-section diameter that increases along the axis of rotation toward the outlet. The conic transition can include a turbulent region in the material passage proximate thereto that mixes the first foodstuff and the second foodstuff.

In still further embodiments of the present disclosure, various methods of emulsifying a first foodstuff with a second foodstuff are provided. Pertinent process steps can include providing the first foodstuff into an inlet of a progressive shear emulsifier, introducing the second foodstuff into the same and/or an additional inlet, rotating an inner body of the progressive shear emulsifier within an outer body of the progressive shear emulsifier, and collecting a resulting emulsified material at an outlet of the progressive shear emulsifier. The inner body and outer body can form a material passage therebetween downstream of the inlet and rotating the inner body can create progressive amounts of shear across the first foodstuff and the second foodstuff passing through the material passage. The progressive amounts of shear can result in all or most of the second foodstuff being emulsified with the first foodstuff while the first and second foodstuffs are within the material passage. The inner body can include an axis of rotation and an outer surface that defines a three-dimensional contour having a size, shape, and one or more directional changes, and at least one conical region having a cross-section diameter that increases along the axis of rotation toward the outlet.

Other apparatuses, methods, features, and advantages of the disclosure will be or will become apparent to one with skill in the art upon examination of the following figures and detailed description. It is intended that all such additional apparatuses, methods, features, and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods for a progressive shear emulsifier. These drawings in no way limit any changes in form and detail that may be made to the disclosure by one skilled in the art without departing from the spirit and scope of the disclosure.

FIG. 1 illustrates a block diagram of an example foodstuff emulsification system according to one embodiment of the present disclosure.

FIG. 2 illustrates in frontal bottom perspective view of an example progressive shear emulsifier according to one embodiment of the present disclosure.

FIG. 3 illustrates in frontal top perspective view an example inner body of the progressive shear emulsifier of FIG. 2 according to one embodiment of the present disclosure.

FIG. 4 illustrates in side cross-section view the progressive shear emulsifier of FIG. 2 according to one embodiment of the present disclosure.

FIG. 5 illustrates in side cross-section view an example alternative progressive shear emulsifier according to one embodiment of the present disclosure.

FIG. 6 illustrates in cutaway perspective view the progressive shear emulsifier of FIG. 5 with a thermal jacket according to one embodiment of the present disclosure.

FIG. 7 illustrates a flowchart of an example method of emulsifying a first foodstuff with a second foodstuff according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, that other embodiments may be used, and that changes may be made without departing from the spirit and scope of the disclosure.

The present disclosure relates in various embodiments to features, apparatuses, systems, and methods for emulsifying materials. The disclosed embodiments can be specifically used for emulsifying various food processing materials, fluids, and arrangements, for example, such as in the production of meat analogue products. In particular, the disclosed embodiments can utilize a progressive shear emulsifier to efficiently emulsify foodstuff materials such as oil, water, methylcellulose, and/or other binders or stabilizers.

While the various materials passing through the material passages of the disclosed systems can loosely be referred to as “fluids,” it will be understood that not all such materials need to be actual fluids, and that these materials can include liquids, gels, slurries, powders (e.g., methylcellulose), viscous doughs, and other items that are able to flow through the disclosed material passages, such as for mixing and emulsification purposes. In addition, while the general conveyance region through the disclosed embodiments is generally referred to herein as a “material passage,” it will be understood that such a region may also be considered a fluid passage in some arrangements. Furthermore, the disclosed progressive shear emulsifiers may also be used for mixing and emulsifying powders, liquids, fluids, and other materials beyond foodstuffs in some arrangements.

Furthermore, it will be understood that the terms “emulsion,” “emulsify,” “emulsifying,” and all variations thereof are not limited strictly to a colloidal suspension of immiscible liquids, and that such terms can broadly refer to any suitable mixture of materials. In particular, such terms can generally refer to any stable mixture of foodstuffs, which can include, for example, water, oil, fat, and/or emulsifying agent(s) such as methylcellulose. The viscosity of such emulsified mixtures can range from, for example, that of water to that of stiff peanut butter or dough. Even higher viscosities may also be possible when emulsifying materials using the disclosed apparatuses, systems, and methods.

In various arrangements, the disclosed progressive shear emulsifiers can deliver high shear forces to a flowing foodstuff mixture to bind a stabilizer or binding ingredient to free water and create a stable emulsion while simultaneously conveying the emulsion through the progressive shear emulsifier. In some embodiments, a premixed foodstuff fluid or material, such as oil and water, or oil, water, and some concentration of methylcellulose, can be provided into an inlet of a progressive shear emulsifier having an internal material passage therethrough. A binder or stabilizer, such as methylcellulose or similar functional ingredient, can also be introduced into the internal material passage via the inlet and/or one or more additional inlets. Movement of the progressive shear emulsifier along the material passage can then create shear stresses in the powders, liquids, fluids, doughs, and/or other materials passing therethrough. Movement can be rotational, such as by rotating an inner body within a stationary outer body of the progressive shear emulsifier.

Although various embodiments disclosed herein discuss emulsifying methylcellulose and free water for purposes of illustration, it will be readily appreciated that the disclosed features, apparatuses, systems, and methods can similarly be used for any relevant emulsion of fluids and/or other pertinent materials. For example, the disclosed progressive shear emulsifiers can also be used with soy lecithin as an alternative to methylcellulose, or to thicken an already stable methylcellulose, oil, and water low viscosity gel. In some situations, the disclosed progressive shear emulsifiers can also be used to emulsify fluids or other materials that are not foodstuff based. Other applications, arrangements, and extrapolations beyond the illustrated embodiments are also contemplated.

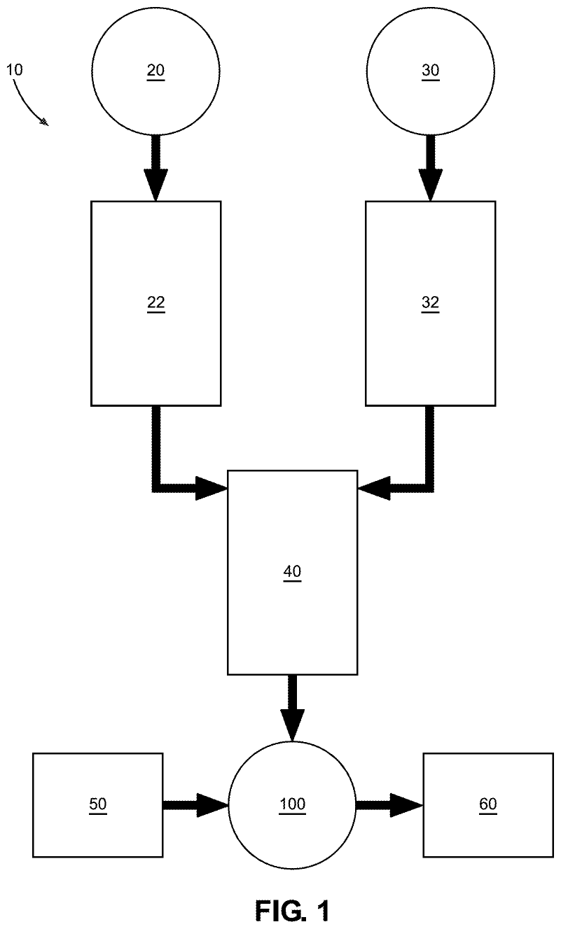

Referring first to FIG. 1, an example foodstuff emulsification system is shown in block diagram format. Foodstuff emulsification system 10 can include, for example, an oil reservoir 20, an oil chiller 22, a water reservoir 30, a water chiller 32, a premix disperser 40, a methylcellulose dosing hopper 50, a progressive shear emulsifier 100, and an emulsified material outlet 60. The oil reservoir 20 can feed oil into the oil chiller 22 and the water reservoir 30 can feed water into the water chiller 32. Suitably chilled oil and water can then be fed therefrom into premix disperser 40, where a suitable suspension of oil and water can be facilitated. This suspension of oil and water can then be provided into progressive shear emulsifier 100, where methylcellulose can also be added from methylcellulose dosing hopper 50. The methylcellulose can be in a powder form, for example. The methylcellulose can then be emulsified with the oil and water mixture within the progressive shear emulsifier 100, after which the emulsified product can be dispensed at emulsified material outlet 60.

Of course, other foodstuffs may also be used, and the examples of oil, water, and methylcellulose are provided here simply for purposes of illustration. In addition, optimal mixing of oil and water or other foodstuffs in premix disperser 40 can depend on various factors, such as the actual fluids and/or other materials, temperatures, and desired properties of the emulsified product dispensed at emulsified material outlet 60. In some arrangements, a fine mixing of oil and water with tiny particle sizes may be ideal, while in other arrangements a coarser mixing may be sufficient. In still further arrangements, a premixture may also include some amount of methylcellulose and/or another binding or emulsion stabilizing material. In general, it will be appreciated that any materials mixing in premix disperser 40 should sufficiently lower the energy barrier in the premixed materials to facilitate suitable emulsification later in the progressive shear emulsifier 100. In some arrangements, powdered methylcellulose might be added to an oil and water mixture over a gradual introduction process, such as at multiple additional inlet locations at and/or immediately after an oil/water inlet to the progressive shear emulsifier 100. In alternative arrangements, an initial material can be an oil and methylcellulose slurry and a second material can be free water. Other alternatives are also possible.

In traditional arrangements, the function performed by progressive shear emulsifier 100 has been accomplished using a bowl chopper. It is generally accepted practice that an industrial bowl chopper must operate on a given small batch of foodstuff dough for at least six minutes, and for larger foodstuff dough batches, thirty minutes or more of processing may be required to suitably emulsify the dough. In addition to this inefficient length of time, substantial cooling methods are needed to counteract the undesirable rise in dough temperature due to the lengthy frictional operation of the bowl chopper.

Testing has shown, however, that binding can be almost immediate when a binder or stabilizer such as methylcellulose is exposed to optimal conditions of ingredient dispersion, shear, turbulence, and temperature. In fact, binding in a small portion of foodstuff mixture can take place in a matter of seconds when shear stress is applied across the entire small portion of mixture at the right temperature. Accordingly, progressive shear emulsifier 100 as disclosed herein is designed to provide shear force efficiently for binding across an entire foodstuff mixture passing therethrough.

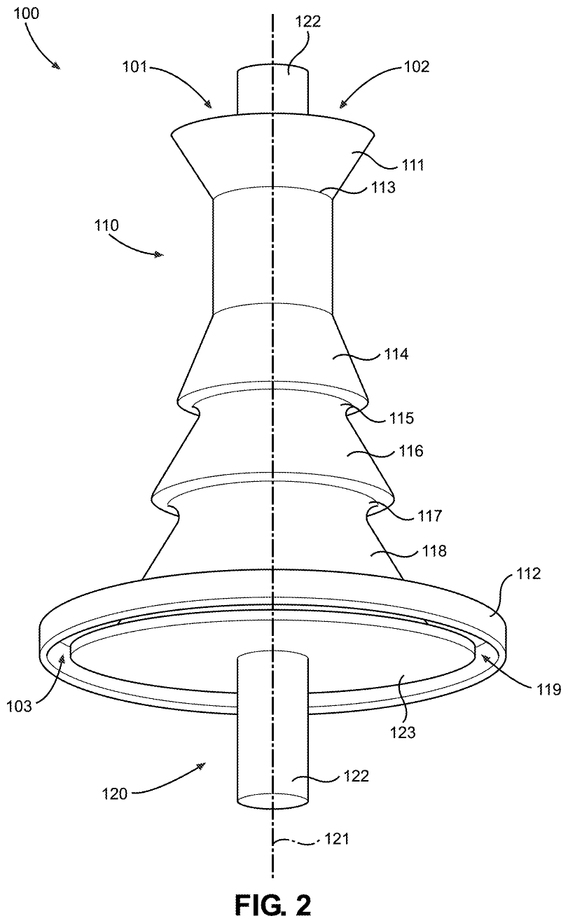

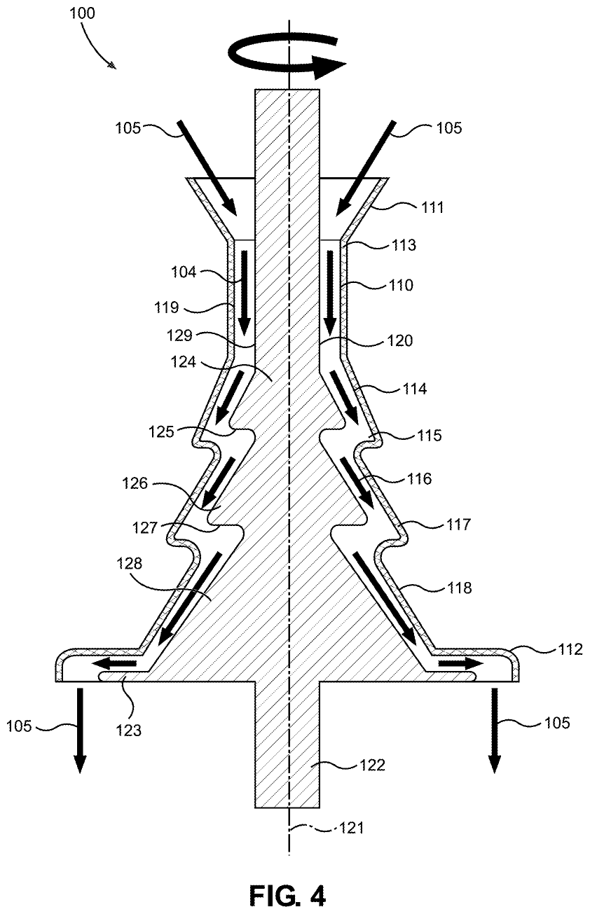

Turning next to FIG. 2, an example progressive shear emulsifier is illustrated in frontal bottom perspective view. Progressive shear emulsifier 100 can include first and second bodies, such as outer body 110 and inner body 120, which can be arranged to form a relatively thin material passage therebetween. In particular, outer body 110 can generally form a cylindrical type outer shell and inner body 120 can fit within this cylindrical type outer shell, with the space between the outer body 110 and inner body 120 forming the material passage (see FIG. 4; 104). In various arrangements, outer body 110 and inner body 120 can move with respect to each other while materials flow through the material passage. For example, outer body 110 can remain stationary while inner body 120 can rotate within outer body 110. In various arrangements, inner body 120 can rotate about a longitudinal rotational axis 121, and one or both of outer body 110 and inner body 120 can be symmetrical about this rotational axis 121. A rotational shaft 122 can be coupled to or integrally formed with inner body 120, such that inner body 120 can be rotationally driven by a system component (not shown) located on shaft 122 remotely from the rest of progressive shear emulsifier 100. Rotation can be constant in one direction, can be at variable speeds, and/or can alternate directions, as detailed below.

The material passage can generally begin at the top of outer body 110 and can generally end at the bottom of outer body 110. Outer body 110 can include an inlet 111 and an outlet 112, one or both of which can generally form funnel type shapes. One or more inputs can be located at or about inlet 111, such as a first foodstuff input 101 and a second foodstuff input 102. The first foodstuff can be, for example, a water-oil mixture, while the second foodstuff can be, for example, methylcellulose. Other input arrangements are also possible. An emulsified material output 103 can be located at or about outlet 112, and inner body 120 can include a bottom plate 123 that forces emulsified materials toward the outlet 112. While not necessary, rotating bottom plate 123 can provide a final shear stress to exiting materials and can also facilitate less collection of unwanted materials along rotational shaft 122 therebelow.

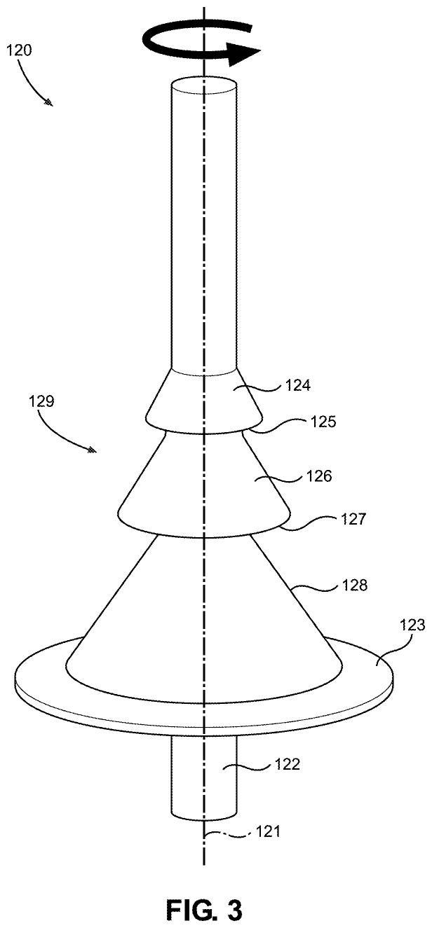

In various embodiments, the relative rotational motion of inner body 120 shears the materials flowing therethrough on all surfaces in which the materials come into contact. For example, outer body 110 can have an inner surface 119 and inner body 120 can have an outer surface (see FIG. 3, 129), with both of these surfaces delivering shear forces to all fluids and other materials contacting the surfaces while there is relative rotational motion between outer body 110 and inner body 120. Outer body 120 can have a thickness that remains relatively constant along most or all regions, and its inner surface 119 can define a three-dimensional contour having a size, a shape, and one or more directional changes. In the exemplary arrangements disclosed herein, the application of shear stresses to passing materials is simply created by the stationary inner surface 119 of the outer body 110 and the moving outer surface of the rotating inner body 120.

In some arrangements, progressive shear emulsifier 100 can include one or more directional changes and one or more conical portions or shapes along the material passage between inner body 110 and outer body 120. These features can facilitate the delivery of progressive amounts of shear as fluids and other materials flow through the material passage. For example, an inlet directional change 113 can be located at the end of inlet 111. Further directional changes can involve conical portions and conical transitions along the material passage. For example, three conical portions 114, 116, 118 can be seen along the outer profile of outer body 110. Matching surface profiles can be located along inner body 120, as shown in FIGS. 3 and 4. A first conic transition 115 can couple the first conical portion 114 to the second conical portion 116, while a second conic transition 117 can couple the second conical portion 116 to the third conical portion 118. Various features and effects of these conical portions and conic transitions are set forth in greater detail below.

In various embodiments, rotating the inner body 120 within the outer body 110 can result in the mixing and emulsifying of materials while conveying the materials through the material passage. The mixing, emulsifying, and conveying of materials can all occur simultaneously, with a combination of inner body motion and gravity driving these actions and may occur in any orientation with respect to gravity.

Continuing with FIG. 3, an example inner body of the progressive shear emulsifier of FIG. 2 is illustrated in frontal top perspective view. Again, inner body 120 can be rotated about and symmetrical about a rotational axis 121. Rotation can be delivered via rotational shaft 122, and bottom plate 123 can function to distribute emulsified materials out of the overall progressive shear emulsifier away from shaft 122. In some arrangements, all of inner body 120 can be integrally formed, and in other arrangements one or more components or features can be coupled together to form the overall inner body 120. Again, relative movement (i.e., rotation) of the inner body 120 within the outer body 110 can create substantial amounts of shear across all materials passing through the material passage between the inlet and outlet, which can emulsify fluids and materials in the material passage. These materials can include, for example, an oil-water mixture and powdered methylcellulose.

Outer surface 129 of inner body 120 can generally define a further three-dimensional contour having a size, shape, and one or more directional changes. This further three-dimensional contour can correlate to the three-dimensional contour at the inner surface 119 of outer body 110 above to form the material passage between the outer and inner bodies 110, 120. Accordingly, the three-dimensional contour along outer surface 129 can include, for example, a first conical portion 124, a first conic transition 125, a second conical portion 126, a second conic transition 127, and a third conical portion 128. Of course, these features can change as more or fewer conical portions and/or conic transitions are used, and the same or similar changes can be present along both inner surface 119 and corresponding outer surface 129.

In various embodiments, one or more grooves, ridges, or other material passage features can be formed along outer surface 129 of inner body 120, inner surface 119 of outer body 110, or both. Such grooves, ridges, and/or other surface features can direct viscous fluids and materials through the material passage between the outer body 110 and inner body 120. In various embodiments, these grooves, ridges, and/or other surface features can provide increased surface area for additional shear force conveyance to flowing materials and can also facilitate additional mixing of the flowing materials to increase overall emulsification effects. For example, a single groove may be formed as a downward directed spiral in outer surface 129 from the top to the bottom of each conical portion 124, 126, 128. Multiple parallel grooves may also be formed in some embodiments. Some arrangements may include grooves or ridges that flow with the rotational direction of inner body 120, while others may include grooves or ridges that flow against rotational direction. Various alternative surface feature arrangements may be used depending upon the final results desired in the emulsified materials exiting the progressive shear emulsifier.

Continuing with FIG. 4 the progressive shear emulsifier of FIG. 2 is illustrated in side cross-section view. As shown in cross-section, the profile of progressive shear emulsifier 100 can resemble that of a “Christmas tree” due to the multiple conical portions. Again, progressive shear emulsifier 100 can include an outer body 110 and an inner body 120 that is located within outer body 110. Outer body 110 can form a stationary shell while inner body 120 rotates about a rotational axis 121 by way of rotational shaft 122. A material passage 104 can exist at some or all volumes between inner surface 119 of outer body 110 and outer surface 129 of inner body 120. Liquids, fluids, and other materials can travel through material passage 104 by way of a material path 105, which is noted by path arrows into inlet 111, through the entire progressive shear emulsifier 100, and out from outlet 112. Other notable items and features for progressive shear emulsifier 100 disclosed and discussed above are shown again in FIG. 4 for purposes of illustration in cross-section view.

The relative geometries of each conic transition 115/125 and 117/127 can effectively create turbulent regions in the material passage, which serve to mix the various fluids and other materials passing therethrough to result in better overall emulsification in the materials exiting the progressive shear emulsifier 100 at outlet 112. To efficiently expose most or all molecules of a material mixture passing through the overall material passage 104 to an immediate field of impact of shear stress at some point, the various fluids and materials passing through conical portions 114/124 and 116/126 can be mixed in turbulent regions at conic transitions 115/125 and 117/127 before being progressively moved to the next conical portions 116/126 and 118/128.

For example, materials flowing between conical portions 114/124 directly at or near inner surface 119 of outer body 110 and outer surface 129 of inner body 120 will tend to experience maximum shear forces due to their proximity to these surfaces, while materials flowing directly at or near the midpoint between surfaces 119 and 129 will experience less shear forces due to being farther away from these surfaces. The materials flowing at or near surfaces 119 and 129 will thus be better emulsified than those materials flowing at the midpoint between these surfaces. To counteract this effect, all flowing materials are mixed in turbulent regions between conic transitions 115/125 before then flowing between conical portions 116/126. In this manner, most materials that flowed between conical portions 114/124 at about the midpoint between surfaces 119 and 129 will flow between conical portions 116/126 at locations that are closer to surfaces 119 and 129, and thus will experience better emulsification through this region. This process can then repeat through conic transitions 117/127 and conical portions 118/128. Additional conic transitions and conical portions may be included as desired.

In various embodiments, each conical portion region 114/124, 116/126, 118/128 can be about six to twelve inches tall, with the overall height of progressive shear emulsifier 100 then being about eighteen to thirty-six inches. Progressive shear emulsifier 100 can also have a width of about eighteen inches. Of course, dimensions may vary, and additional heights, widths, and number of conical portions and conic transitions may be altered as desired. Furthermore, different sizes can be used depending upon what is optimal for the materials being emulsified. For example, while a twenty-four inch tall emulsifier may work well for oil-water mixtures and powdered methylcellulose, a taller or shorter emulsifier may be more appropriate for other material mixtures. For example, material mixtures using citrus fiber rather than methylcellulose may experience better emulsification results with emulsifiers that are larger or smaller.

As will be readily appreciated, the geometries and rotational movements of the progressive shear emulsifier can result not only in progressive shear stresses to materials as they pass therethrough, but also in a high viscous pumping action to convey the liquids, fluids, mixtures, doughy substances, and/or other materials passing therethrough. Such a high viscous pumping action can be enhanced in the event that grooves, ridges, or other surface features are strategically formed along the surfaces of the material passage. Determination of optimal shear rates to produce stable and desirable emulsions while maximizing emulsion outputs, effecting efficient pumping actions, and minimizing mechanical energy inputs can be obtained through routine experimentation with various material properties and device properties and dimensions, as will be readily appreciated.

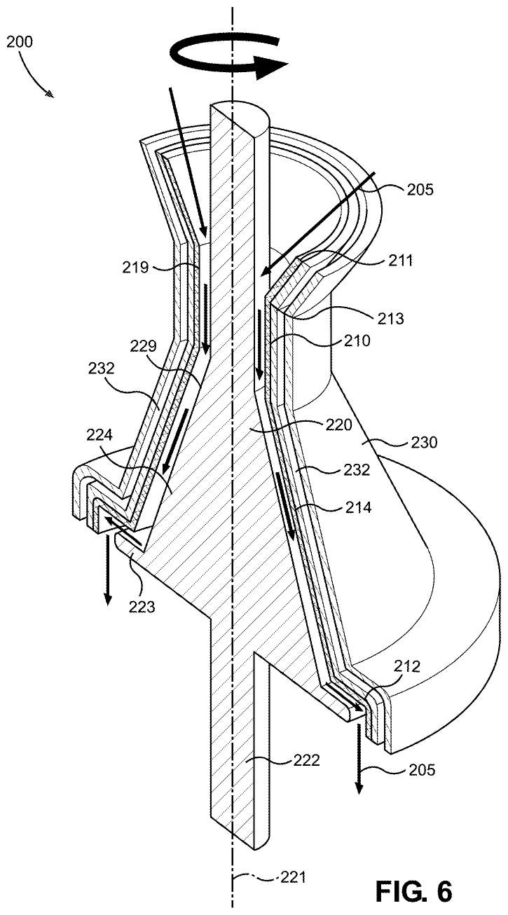

While bowl choppers tend to require significant considerations for cooling due to the high amount of processing time required, the faster emulsification times of the disclosed progressive shear emulsifiers result in less of a need for cooling. In the event that cooling or tight temperature controls are desired, an insulating jacket can be placed around outer body 110. Alternatively, or in addition, an internal cooling flow can be circulated through outer body 110 and/or inner body 120. Still further, the input materials, such as oil, water, and methylcellulose powder, can be suitably chilled prior to introducing these materials at inlet 111. Further details regarding cooling are provided with respect to FIG. 6 below.

In various embodiments, progressive shear emulsifier 100 as shown can be readily disassembled or taken apart, such as for cleaning in an industrial dishwasher. Accordingly, the shell form of outer body 110 may slide off from inner body 120 in some arrangements. In some embodiments, outer body 110 may take the form of a hinged clamshell arrangement that is able to open and be removed from inner body 120. Also, inner body 120 may be decoupled from at least a portion of rotating shaft 122, such that it may also be removed and placed into an industrial dishwasher or other cleaning device.

In some arrangements, outer body 110 and/or inner body 120 may be interchangeable with other identically or similarly shaped outer bodies and/or inner bodies. For identically shaped and sized bodies, this can streamline production processes where one body is swapped in while another body is being cleaned or repaired. For bodies of differing sizes, this can result in the creation of material passages of differing thicknesses, which may be more suitable for different material mixtures and emulsifications. For example, inner body 120 may remain constant in some arrangements while different outer bodies 110 of varying sizes and dimensions can be interchangeably placed around inner body 120 with differing emulsification effects. Conversely, outer body 110 may remain constant while different inner bodies of varying sizes and shapes may be interchanged.

The disclosed progressive shear emulsifier 100 delivers many advantages over other foodstuff emulsifiers, such as a bowl chopper. In particular, progressive shear emulsifier 100 can deliver shear forces to most or all of the materials passing through its material passage and provide turbulent mixing on a small scale volume to expose all material particles to shear, which is substantially more efficient than a bowl chopper or other existing emulsification processes for high viscous materials. Emulsification can be accomplished in significantly reduced times over conventional methods, and material cooling can be more readily accomplished through the relatively increased surface areas of the disclosed geometries. Progressive shear emulsifier 100 can also be a continuous processing machine that is gravity assisted, which eliminates any need for added material conveyances and results in energy savings. Progressive shear emulsifier 100 is also bladeless with no risk of metal-on-metal contact, thereby reducing wear and tear, reducing worker safety issues, and reducing fractured metal contamination risks. Other advantages will also be apparent to those of skill in the art.

It will also be appreciated that multiple conical portions may not be necessary to achieve many or all of the advantages of the example progressive shear emulsifier 100 disclosed and detailed above. In fact, some of these quick emulsification advantages have been found to exist even in small scale nested cylindrical shapes rotating within each other. For purposes of illustration, another simplified example with conical profiles will now be provided.

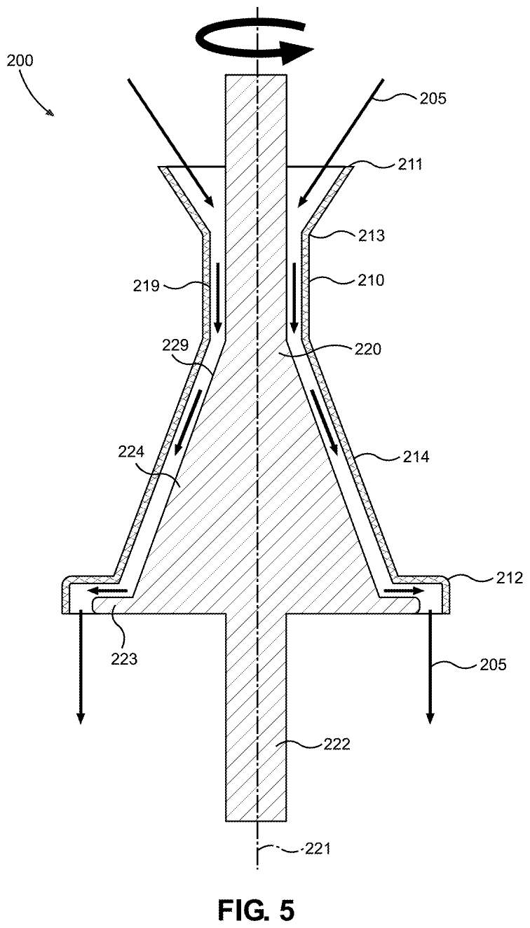

FIG. 5 illustrates in side cross-section view of an example alternative progressive shear emulsifier. Alternative progressive shear emulsifier 200 can be a simpler version of the above progressive shear emulsifier 100. Rather than have three separate conical portions, alternative progressive shear emulsifier 200 can have only one such portion, which is formed by outer conical shape 214 of outer body 210 and inner conical shape 224 of inner body 220. There are thus no additional conical portions and no conic transitions. Despite having only one conical portion, alternative progressive shear emulsifier 200 can have other features similar to the foregoing emulsifier 100. These can include, for example, inlet 211, outlet 212, inlet directional change 213, rotational axis 221, rotational shaft 222, and bottom plate 223, as well as inner surface 219 of outer body 210 and outer surface 229 of inner body 220. Material path 205 can be a simplified version of material path 105 above, due to fewer conical portions.

FIG. 6 illustrates in cutaway perspective view, the alternative progressive shear emulsifier of FIG. 5 with a thermal jacket. As noted above, an insulating or thermal jacket 230 can be placed around outer body 210 in the event that cooling or tight temperature controls are desired. While temperature issues can be problematic in a bowl chopper due to small surface areas compared to overall mass, the disclosed progressive shear emulsifiers advantageously have narrow shear gaps and high surface area to volume ratios. Conduction based cooling can thus be utilized more easily and efficiently, such as by the use of thermal jacket 230 and/or other cooling techniques that take advantage of comparatively increased surface areas.

Thermal jacket 230 can be formed from an insulating and/or cooling material and can be of a sufficient thickness to maintain cooled temperatures within the material path 205. If desired, thermal jacket 230 can include an internal cavity 232 to provide for flow of a cooling fluid that draws heat from materials flowing through the material path 205 and facilitates maintaining a cooled temperature therein. In the event that an internal cavity 232 is used for cooling fluid flow, at least the internal wall of thermal jacket 230 can be formed of a material conducive to heat transfer, such as stainless steel. It will be readily appreciated that a similar thermal jacket can be used for progressive shear emulsifier 100 above or any alternatively shaped progressive shear emulsifier. In other embodiments, thermal jacket 230 can be foregone in lieu of a more complex outer body 210 that also includes an internal cavity for cooling fluid flow.

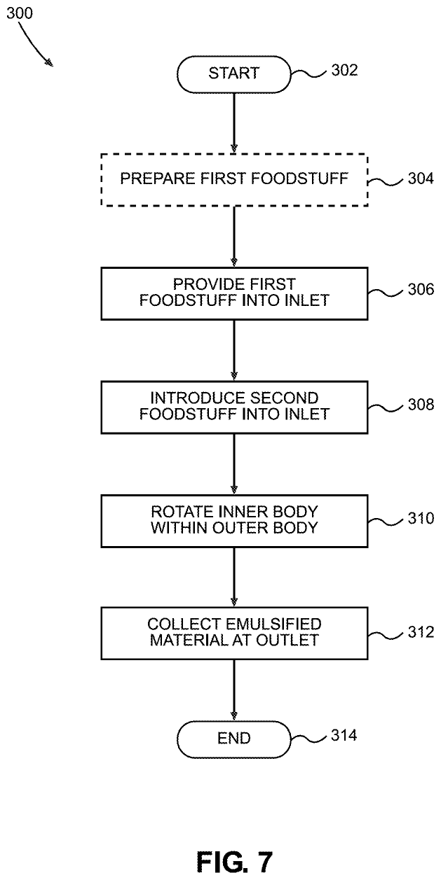

Finally, FIG. 7 provides a flowchart of an example method 300 of emulsifying a first foodstuff with a second foodstuff. After a start step 302, an optional first process step 304 can include preparing a first foodstuff. This can be, for example, premixing to disperse oil and water to a suitable level of fine particle mix. At process step 306, a first foodstuff can be provided into an inlet of a progressive shear emulsifier, such as that which is described above. This first foodstuff can be an oil and water mixture, for example.

At process step 308 a second foodstuff can be introduced into the inlet and/or one or more alternative inlets of the progressive shear emulsifier. This second foodstuff can be powdered methylcellulose, for example. In some embodiments, process steps 306 and 308 can be performed simultaneously, such as where the first and second foodstuff are premixed before being introduced into the inlet. For example, a premixture of oil, water, and methylcellulose can be provided into the inlet all at once.

At subsequent process step 310, an inner body of the progressive shear emulsifier can be rotated within an outer body of the progressive shear emulsifier. The inner body and outer body can form a material passage therebetween downstream of the inlet and rotating the inner body can create progressive amounts of shear across the first foodstuff and the second foodstuff passing through the material passage. These progressive amounts of shear can result in most or all of the second foodstuff being emulsified with the first foodstuff while the first and second foodstuffs are within the material passage. For example, this can involve emulsifying methylcellulose powder with an oil and water mixture.

As noted above, the inner body can include an axis of rotation and an outer surface that defines a three-dimensional contour having a size, shape, and one or more directional changes, and at least one conical region having a cross-section diameter that increases along the axis of rotation toward the outlet, which features can contribute to creating progressive amounts of shear during rotation of the inner body. As will be readily appreciated, rotating the inner body within the outer body can result in the intermittent mixing of materials while simultaneously conveying the materials through the material passage.

As also noted above, rotating the inner body within the outer body can involve different modes of rotation. In some arrangements, the inner body can be rotated at a constant speed. In other arrangements, the inner body can be rotated at a variable speed, such as rapidly, slowly, and back to rapidly. Pauses in rotation may also be introduced. In some embodiments, an oscillating rotation pattern may be used, such as rotation in a clockwise direction alternating with rotation in a counterclockwise direction. For example, a single or partial revolution in one direction can be followed with a single or partial revolution in the opposite direction, with repeated directional changes after each single or partial revolution. Multiple revolutions before reversing direction may also be used. Experimentation with various speed and rotational patterns can determine those which work better for particular materials being processed.

At the next process step 312, the emulsified material can be collected at an outlet of the progressive shear emulsifier. If desired, the method can then repeat to emulsify additional foodstuffs. Alternatively, the method then ends at end step 314.

It will be appreciated that the foregoing method may include additional steps not shown, and that not all steps are necessary in some embodiments. For example, additional steps may include the turbulent mixing of materials at conic regions and/or exchanging one outer body for a different outer body. Furthermore, the order of steps may be altered as desired, and one or more steps may be performed simultaneously. For example, some continuous processes may result in all of steps 304-312 being performed simultaneously, albeit with different materials at different stages of the overall process at any given point in time.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An apparatus configured to emulsify materials, the apparatus comprising:
a first body having an inlet, an outlet, and a first surface between the inlet and outlet, wherein the first surface defines a first three-dimensional contour having a first size, a first shape, and a first set of one or more directional changes; and
a second body having a second surface that defines a second three-dimensional contour having a second size, a second shape, and a second set of one or more directional changes, the second three-dimensional contour correlating to the first three-dimensional contour to form a material passage between the first body and second body, wherein movement of the second body relative to the first body creates substantial amounts of shear from the inlet to the outlet across all materials passing through the material passage, the substantial amounts of shear emulsifying a first material with a second material in the material passage, and wherein the first and second sets of one or more directional changes combine to form at least one turbulent region in the material passage proximate thereto, the at least one turbulent region causing mixing of the first material and second material.

2. The apparatus of claim 1, wherein the first material includes free water, the second material includes methylcellulose, in one application, and substantial amounts of shear and turbulence are sufficient to bind the methylcellulose to the free water.

3. The apparatus of claim 1, wherein the second body substantially fits within the first body.

4. The apparatus of claim 3, wherein the first body remains stationary while the second body rotates within the first body.

5. The apparatus of claim 4, wherein the first surface includes substantially most inner surface regions of the first body and the second surface includes substantially most outer surface regions of the second body.

6. The apparatus of claim 4, wherein the second body includes one or more features configured to facilitate rotational movement of the second body.

7. The apparatus of claim 4, wherein a first portion of the second surface forms a first conical shape with respect to an axis of rotation of the second body, the first conical shape having a cross-section diameter that increases toward the outlet.

8. The apparatus of claim 7, wherein the substantial amounts of shear include shear increases as materials travel along the first conical shape.

9. The apparatus of claim 7, wherein the second surface includes one or more grooves configured to facilitate material flow therealong.

10. The apparatus of claim 7, wherein a second portion of the second surface forms a second conical shape with respect to the axis of rotation of the second body, the second conical shape having a cross-section diameter that increases toward the outlet.

11. The apparatus of claim 10, wherein a directional change of the second surface includes a conic transition from an end of the first conical shape to a start of the second conical shape.

12. The apparatus of claim 11, wherein the conic transition creates a first turbulent region in the material passage proximate thereto, the first turbulent region mixing the first material and second material.

13. The apparatus of claim 7, wherein most of the second material is emulsified with the first material before the first and second materials reach an end of the first conical shape.

14. The apparatus of claim 1, further comprising:
a thermal jacket located around the first body, wherein the thermal jacket facilitates cooling of the material passage.

15. A progressive shear emulsifier configured to emulsify a first foodstuff with a second foodstuff, the progressive shear emulsifier comprising:
an outer body having a central opening therethrough, an inlet, an outlet, and an inner surface along the central opening between the inlet and outlet, wherein the inner surface defines a first three-dimensional contour having a first size, a first shape, and a first set of one or more directional changes; and
an inner body positioned within the central opening and configured to rotate with respect to the outer body, the inner body having an axis of rotation along the central opening and an outer surface that defines a second three-dimensional contour having a second size, a second shape, and a second set of one or more directional changes that correlate to the first three-dimensional contour to form a material passage between the outer body and inner body, wherein rotation of the inner body within the outer body creates progressive amounts of shear across the first foodstuff and the second foodstuff passing through the material passage from the inlet to the outlet, the progressive amounts of shear resulting in most of the second foodstuff being emulsified with the first foodstuff while the first and second foodstuffs are within the material passage, and wherein the first and second sets of one or more directional changes combine to form at least one turbulent region in the material passage proximate thereto, the at least one turbulent region causing mixing of the first foodstuff and second foodstuff.

16. The progressive shear emulsifier of claim 15, wherein the first foodstuff includes an oil and free water mixture and the second foodstuff includes methylcellulose or the first foodstuff contains a less viscous gel comprised of oil, methylcellulose, and water and the second foodstuff contains additional methylcellulose.

17. The progressive shear emulsifier of claim 16, wherein the inlet is configured to receive a premixed oil, water, and methylcellulose mixture.

18. The progressive shear emulsifier of claim 15, wherein the outer body and the inner body are both symmetrical about the axis of rotation.

19. The progressive shear emulsifier of claim 15, wherein the inner body includes a first conical region having a cross-section diameter that increases along the axis of rotation toward the outlet.

20. The progressive shear emulsifier of claim 19, wherein the inner body further includes a second conical region after the first conical region and a conic transition between the first and second conical regions, the second conical region having a cross-section diameter that increases along the axis of rotation toward the outlet, and wherein the conic transition includes a turbulent region in the material passage proximate thereto that mixes the first foodstuff and the second foodstuff.

21. The progressive shear emulsifier of claim 15, wherein the outer surface of the inner body includes one or more grooves configured to facilitate material flow therealong.

22. The progressive shear emulsifier of claim 15, further comprising:
a thermal jacket located around the outer body, wherein the thermal jacket facilitates cooling of the material passage.

23. A method of emulsifying a first foodstuff with a second foodstuff, the method comprising:
providing the first foodstuff into an inlet of a progressive shear emulsifier;
introducing the second foodstuff into the inlet;
rotating an inner body of the progressive shear emulsifier within an outer body of the progressive shear emulsifier, the inner body and outer body forming a material passage therebetween downstream of the inlet, wherein rotating the inner body creates progressive amounts of shear across the first foodstuff and the second foodstuff passing through the material passage, the progressive amounts of shear resulting in most of the second foodstuff being emulsified with the first foodstuff while the first and second foodstuffs are within the material passage; and
collecting a resulting emulsified material at an outlet of the progressive shear emulsifier.

24. The method of claim 23, wherein the inner body includes an axis of rotation and an outer surface that defines a three-dimensional contour having a size, shape, and one or more directional changes, and at least one conical region having a cross-section diameter that increases along the axis of rotation toward the outlet.

25. The method of claim 23, wherein rotating the inner body includes varying the speed and/or direction of rotation.
